(19) United States
(12) Patent Application Publication
(10) Pub. No.: US 2026/0210474 A1
(43) Pub. Date: Jul. 23, 2026

(54) FLUID CONNECTOR

(71) Applicant: ACES ELECTRONICS CO., LTD., Taoyuan City (TW)

(72) Inventors: Rong-Hsun KUO, Taoyuan City (TW); Kuei-Ta HSIEH, Taoyuan City (TW)

(21) Appl. No.: 19/297,414

(22) Filed: Aug. 12, 2025

(30) Foreign Application Priority Data
Jan. 21, 2025 (TW) 114200858

(51) Int. Cl. F16L 37/38

(52) U.S. Cl. CPC F16L 37/38

(57) ABSTRACT

A fluid connector has a tube body, a valve, a spring, and a supporting collar. The supporting collar is held securely in a rear opening of the tube body by a resilient engaging member without using a resilient supporting member. The resilient engaging member is arranged on an outer surface of the collar body and is separated from a fluid path of the tube body by the collar body. Thus, the resilient engaging member is kept from being immersed in fluid for a long time.

### CROSS-REFERENCE TO RELATED APPLICATIONS

This application is based upon and claims priority under 35 U.S.C. 119 from Taiwan Patent Application No. 114200858 filed on Jan. 21, 2025, which is hereby specifically incorporated herein by this reference thereto.

### BACKGROUND OF THE INVENTION

### 1. Field of the Invention

The present invention relates to a connector, and more particularly to a fluid connector.

### 2. Description of the Prior Arts

With reference to FIG. 5, a conventional fluid connector includes a tube body 51, a valve 52, and a spring 53. The valve 51 is mounted in a front opening 511 of the tube body 51. The spring 53 has two ends abutting respectively the valve 52 and a rear opening 512 of the tube body 51. When the fluid connector is inserted into another fluid connector, the valve 52 will be moved toward the rear opening 512, and the spring 53 is compressed. Thus, the valve 52 is kept from sealing the front opening 511, and the front opening 511 communicates with the rear opening 512. Accordingly, fluid will pass through the fluid connector.

To increase the number of plugging and unplugging times of the fluid connector 50, the stability of the spring 53 is critical. A stable structure for the spring 53 abutting the rear opening 512 has to be provided. With reference to FIG. 5, an annular engaging recess 513 is formed in an inner surface of the tube body 51 adjacent to the rear opening 512. A resilient supporting member 60 is inserted into the engaging recess 513 via the rear opening 512. Multiple resilient arms 61 formed on a rear end of the resilient supporting member 60 will be compressed inward to allow the resilient arms 61 to pass through the rear opening 512. When the resilient arms 51 enter into the engaging recess 513, the resilient arms 61 expands to engage with the engaging recess 513. Accordingly, the resilient supporting member 60 is held securely in a fluid path 510 of the tube body 51. An annular recess 62 is defined in a front end of the resilient supporting member 60 to hold an end of the spring 53 inside, such that the spring 53 can be stably held inside the tube body 51.

However, the conventional resilient supporting member 60 can support stably the spring 53 inside the tube body 51, the resilient supporting member 60 tends to become brittle and to lose elasticity after being immersed in fluid for a long time. In addition, the spring 53 will continue to exert pressure on the resilient supporting member 60 during the plugging and unplugging processes, so the resilient supporting member 60 is accelerated to be damaged. Therefore, the useful life of the conventional fluid connector will be reduced, and the conventional fluid connector has to be improved.

To overcome the shortcomings, the present invention provides a fluid connector to mitigate or to obviate the aforementioned problems.

### SUMMARY

The objective of the present invention is to provide a fluid connector that has a stable structure and can be used for a long term.

To achieve the aforementioned objective, the fluid connector has
a tube body having a first front opening, a fluid path, and a first rear opening communicating with each other from front to rear;
a supporting collar mounted in the first rear opening of the tube body and comprising
   a collar body having an inner diameter smaller that an inner diameter of the fluid path of the tube body; and
   a resilient engaging member located between an outer surface of the collar body and an inner surface of the first rear opening and securely held the collar body in the first rear opening of the tube body;
   a valve mounted slidably in the fluid path of the tube body and selectively sealing the first front opening of the tube body; and
   a spring held in the fluid path of the tube body and having two ends abutting respectively with the valve and a front end of the supporting collar.

With such an arrangement, n non-resilient supporting collar is applied on the fluid connector in accordance with the present invention. The supporting collar is securely held in the front rear opening of the tube body by a resilient engaging member. Because the resilient engaging member is mounted on an outer surface of the collar body, the resilient engaging member is separated from the fluid path of the tube body by the collar body. Therefore, the resilient engaging member is kept from being immersed in the fluid for a long time, and the service life of the resilient engaging member can be kept from being reduced. The useful life of the fluid connector having the resilient engaging member can be prolonged.

To achieve the aforementioned objective, another fluid connector has
a tube body having a first front opening, a fluid path, and a first rear opening communicating with each other from front to rear, wherein a diameter of the first rear opening is larger than an inner diameter of the fluid path, and an abutting wall is formed at a connection position between the first rear opening and the fluid path;
a supporting collar mounted in the first rear opening of the tube body and comprising
   a collar body having an inner diameter smaller than the inner diameter of the fluid path of the tube body and a front end abutting with the abutting wall of the tube body; and
   a first thread formed on an outer surface of the collar body and screwed onto an inner surface of the first rear opening of the tube body;
a valve mounted slidably in the fluid path of the tube body and selectively sealing the first front opening of the tube body; and
a spring held in the fluid path of the tube body and having two ends abutting respectively with the valve and a front end of the supporting collar.

With such an arrangement, n non-resilient supporting collar is applied on the fluid connector in accordance with the present invention. The supporting collar is securely held in the front rear opening of the tube body by a first thread. Because the first thread is formed on an outer surface of the collar body, the first thread is separated from the fluid path of the tube body by the collar body. Therefore, the first thread is kept from being immersed in the fluid for a long time, and the service life of the first thread can be kept from being reduced. The combination surface between the supporting collar and the tube body can be enlarged, and the combination between the supporting collar and the tube body is firm. The useful life of the fluid connector with the first thread can be prolonged.

### BRIEF DESCRIPTION OF THE DRAWINGS

FIG. 1 is an exploded perspective view of a first embodiment of a fluid connector in accordance with the present invention;

FIG. 2A is a cross-sectional side view of the fluid connector in FIG. 1;

FIG. 2B is an enlarged cross-sectional side view of the fluid connector in FIG. 2;

FIG. 3 an exploded perspective view of a first embodiment of a fluid connector in accordance with the present invention;

FIG. 4A is a cross-sectional side view of the fluid connector in FIG. 3;

FIG. 4B is an enlarged cross-sectional side view of the fluid connector in FIG. 4; and

FIG. 5 is a cross-sectional side view of a conventional fluid connector in accordance with the prior art.

### DETAILED DESCRIPTION OF THE EMBODIMENTS

The present invention is related to a fluid connector. Other objectives, advantages and novel features of the invention will become more apparent from the following detailed description when taken in conjunction with the accompanying drawings.

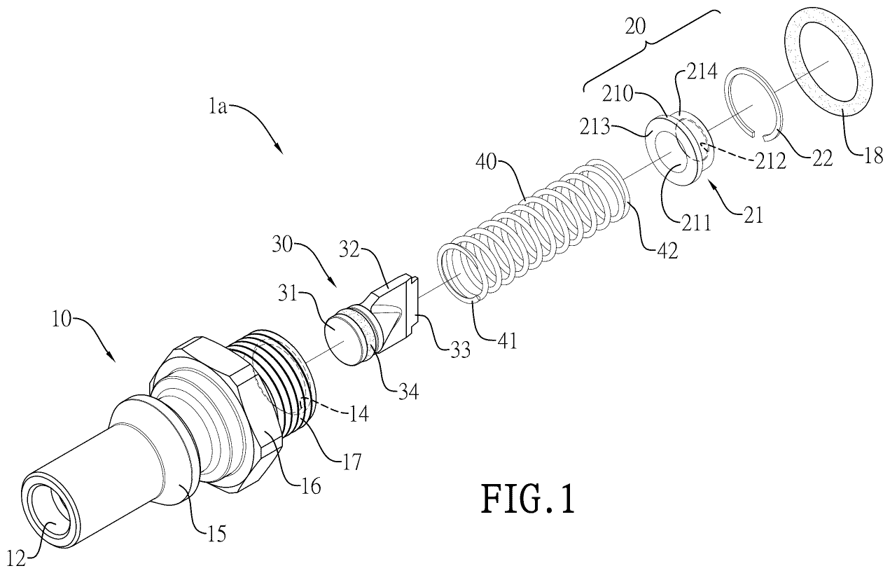

With reference to FIG. 1, the fluid connector 1a in accordance with the present invention comprises a tube body 10, a supporting collar 20, a valve 30, and a spring 40.

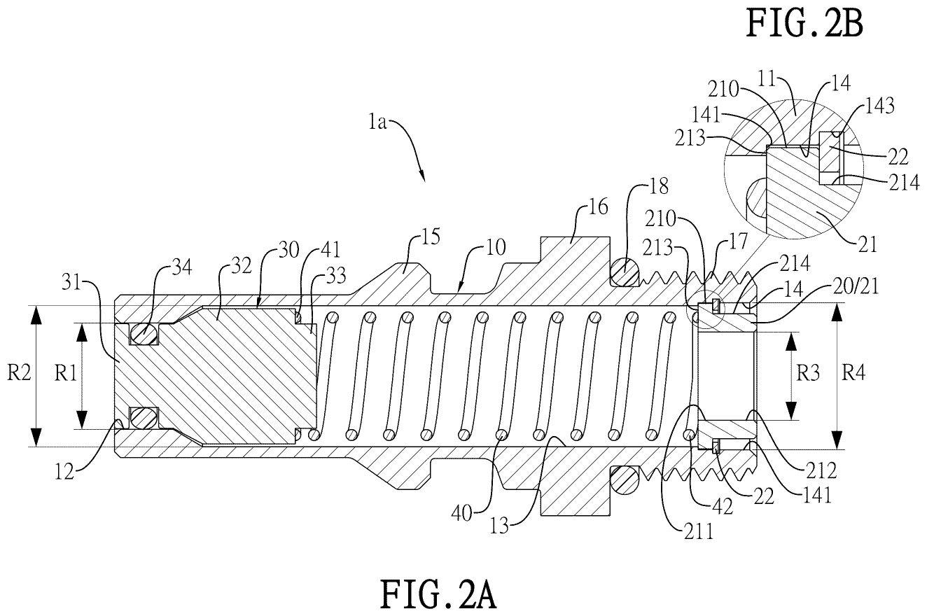

With reference to FIG. 2, the tube body 10 includes a first front opening 12, a fluid path 13, and a first rear opening 14 communicating with each other from front to rear. In the present embodiment, the diameter R1 of the first front opening 12 is smaller than the inner diameter R2 of the fluid path 13 (R1<R2). In an embodiment, the diameter R4 of the first rear opening 14 is not smaller than the inner diameter R2 of the fluid path 13. In the present embodiment, the diameter R4 of the first rear opening 14 is larger than the inner diameter R2 of the fluid path 13. Thus, an abutting wall 141 is formed in the tube body at a connection position between the fluid path 13 and the first rear opening 14. In an embodiment, when the tube body 10 is applied as a male connector, is applied to be inserted into a female connector and to be engaged with an engaging element of the female connector. Therefore, an outer side 100 of the tube body 10 has an outer engaging portion 15, a protruding flange 16, an outer thread 17 from front to back, and a second seal 18 is mounted around the outer side 100 of the tube body 10 and located between the protruding flange 16 and the outer thread 17.

The supporting collar 20 is held in the first rear opening 14 of the tube body 10 and includes a collar body 21 and a resilient engaging member 22. The collar body 21 has a second front opening 211 and a second rear opening 212 opposite each other. An inner diameter R3 of the collar body is smaller than the inner diameter R2 of the fluid path 13 and the diameter R1 of the first front opening (R3<R1<R2). A largest outer diameter of the collar body 21 matches with the diameter R4 of the first rear opening 14. In the present embodiment, a front end 213 of the collar body 21 partially abuts the abutting wall 141 of the tube body 10. In the present embodiment, an annular flange 214 is formed on an outer surface 210 of the collar body 21. An annular groove 143 is formed in an inner surface 142 of the first rear opening 142 of the tube body 10 at a position corresponding to the annular flange 214. A width of the annular groove 143 matches with a thickness of the resilient engaging member 22. Thus, the resilient engaging member 22 can be engaged partially with the annular groove 143 to hold the collar body 21 securely inside the first rear opening 14 of the tube body 10. In addition, the collar body is made of metal.

The engaging portion 22 is partially engaged with the inner surface 142 of the first rear opening 14 of the tube body 10 and abuts with a rear end of the of the collar body 21 of the supporting collar 20. The rear end is opposite to the front end 213. In the present embodiment, the resilient engaging member 22 may be a C-shape buckle or a coil buckle.

The valve 30 is mounted slidably in the fluid path 13 of the tube body 10 and selectively seals the first front opening 12 of the tube body 10. In the present embodiment, the valve 30 includes a head 31, a valve body 32, and a tail 33. The head 31 matches with the first front opening 12. The valve body 32 matches the fluid path 13. The spring 40 is mounted around the tail 33. In an embodiment, a first seal 34 is mounted around the head 31. When the head 31 is located at the first front opening 12, the first seal 34 is located between the head 31 and the first front opening 12 to provide an excellent sealing effect to the first front opening 12.

The spring 40 is held in the fluid path 13 of the tube body 10. An end 41 of the spring 40 abuts the valve 30. Specifically, the end 41 of the spring 40 abuts with the valve body 32, and the other end 42 of the spring 40 abuts the front end 213 of the supporting collar 20.

With such an arrangement of the first embodiment of the fluid connector 1a, the collar body 21 of the supporting collar 20 is annular in shape and without a resilient supporting member. The collar body 21 is securely held in the front rear opening 14 of the tube body 10 by the resilient engaging member 22. Because the resilient engaging member 22 is mounted around the collar body 21, the resilient engaging member 22 is separated from the fluid path 13 of the tube body 10 by the collar body 21. Therefore, the resilient engaging member 21 is kept from being immersed in the fluid for a long time, and the service life of the resilient engaging member 21 can be kept from being reduced. The useful life of the fluid connector 1a having the resilient engaging member 21 can be prolonged.

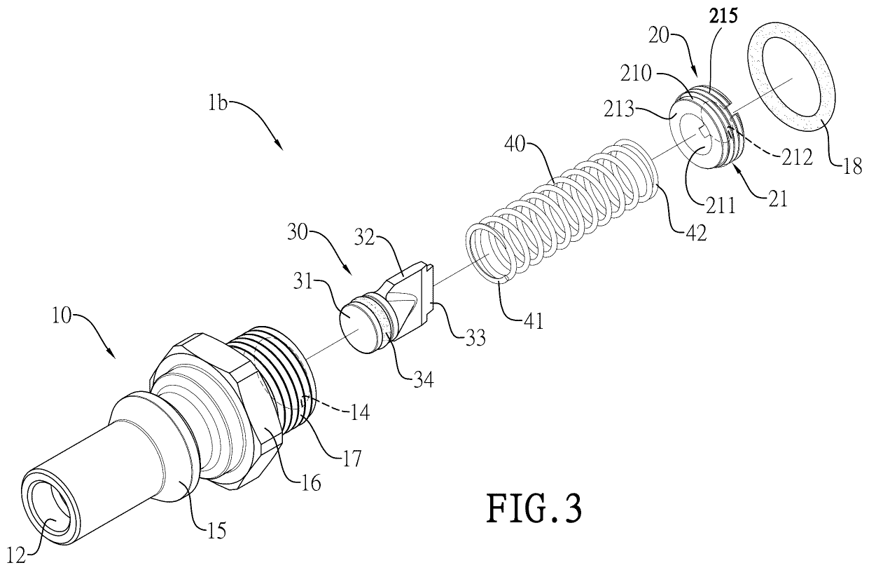

With reference to FIG. 3, a second embodiment of a fluid connector 1b is similar to the fluid connector 1a in the first embodiment and includes a tube body 10, a supporting collar 20, a valve 30, and a spring 40. The valve 30 and the spring 40 are same as those in the first embodiment, so further description is omitted.

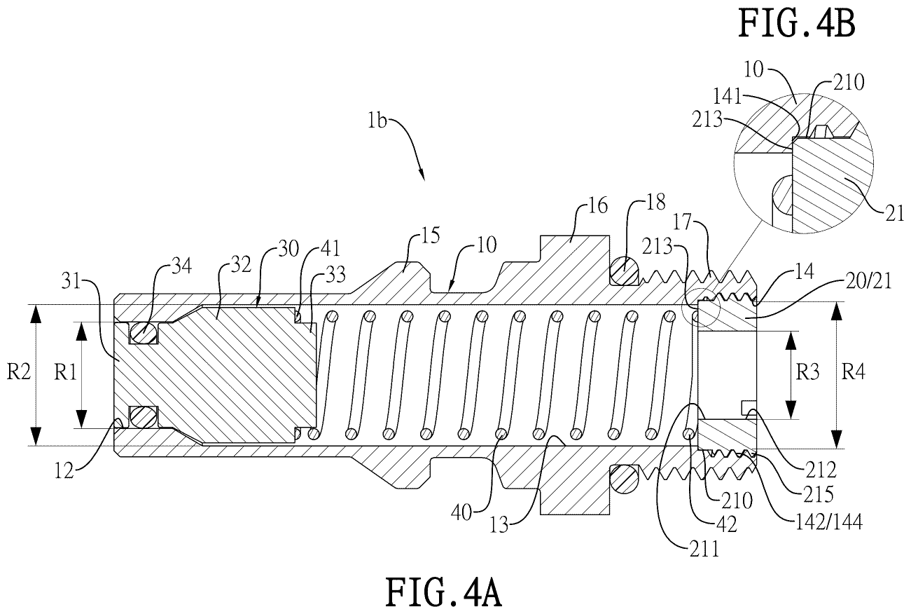

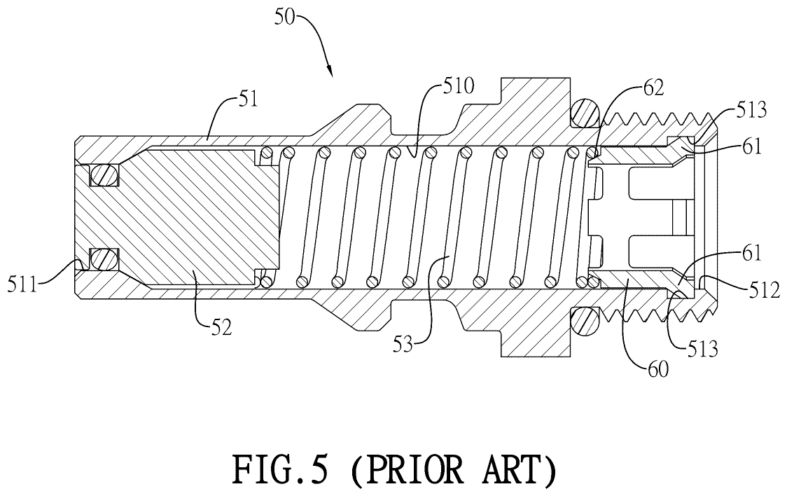

With reference to FIGS. 4 and 4A, the tube body 10 in the present embodiment further includes a thread 144. The thread 144 is formed on the inner surface 142 of the first rear opening 14. The thread 144 may be a recessed inner thread.

In the present embodiment, the supporting collar 20 includes a collar body 21 and a first thread 215. The first thread 215 is formed integrally around the outer surface 210 of the collar body 21. The first thread 215 may be a protruding outer thread matching the inner thread of the first rear opening 14 of the tube body 10. With the engagement between the threads, the collar body 21 can be securely screwed onto the first rear opening 14 of the tube body 10.

With such an arrangement of the second embodiment of the fluid connector 1b in accordance with the present invention, the supporting collar 20 without a resilient engaging member is directly screwed onto the inner surface 142 of the first rear opening 14 of the tube body with the threads. In addition, the first thread 215 is formed on the outer surface of the collar body 21, such that the first thread 215 is also separated from the fluid path 13 of the tube body 10 by the collar body 21. Thus, the first thread 215 is kept from being immersed in fluid for a long time, so the useful life of the first thread 215 can be prolonged. In addition, because the supporting collar 20 is screwed onto the inner surface 142 of the first rear opening 41 of the tube body 10 by the first thread 215, the combination surface between the collar body 21 and the tube body 10 is enlarged. Thus, the combination of the collar body 21 and the tube body 10 is firm. Therefore, the useful life of the fluid connector 1b can be prolonged.

With such an arrangement, with the two embodiments of the fluid connector in accordance with the present invention having a resilient engaging member or a first thread for be held securely in the first rear opening of the tube body, the resilient engaging member and the first thread are all located at an outer surface of the collar body and are separated from the fluid path of the tube body by the collar body. The resilient engaging member and the first thread are kept from being immersed in the fluid for a long time and from being shortened in their useful life. Thus, the useful life of the fluid connector can be effectively prolonged. In addition, an abutting wall can be formed between the first rear opening and the fluid path. When the front end 213 of the collar body abuts the abutting wall, this means that the supporting collar is in the right position so as to assist in the assembly of the tube body and the supporting collar.

Even though numerous characteristics and advantages of the present invention have been set forth in the foregoing description, together with details of the structure and features of the invention, the disclosure is illustrative only. Changes may be made in the details, especially in matters of shape, size, and arrangement of parts within the principles of the invention to the full extent indicated by the broad general meaning of the terms in which the appended claims are expressed.

What is claimed is:

1. A fluid connector comprising:
a tube body having a first front opening, a fluid path, and a first rear opening communicating with each other and arranged from a front end to a rear end of the tube body;
a supporting collar mounted in the first rear opening of the tube body and comprising
a collar body having an inner diameter smaller than an inner diameter of the fluid path of the tube body; and
a resilient engaging member located between an outer surface of the collar body and an inner surface of the first rear opening and securely held in the first rear opening of the tube body;
a valve mounted slidably in the fluid path of the tube body and selectively sealing the first front opening of the tube body; and
a spring held in the fluid path of the tube body and having two ends abutting respectively with the valve and a front end of the supporting collar.

2. The fluid connector as claimed in claim 1, wherein
an annular flange is formed on the outer surface of the collar body;
an annular groove is defined in the inner surface of the first rear opening of the tube body at a position corresponding to the annular flange and having a width matching with a thickness of the resilient engaging member; and
the resilient engaging member is engaged partially with the annular groove.

3. The fluid connector as claimed in claim 2, wherein
the resilient engaging member is a C-shaped buckle or a coil buckle; and
the tube body is made of metal.

4. The fluid connector as claimed in claim 3, wherein
a diameter of the first rear opening is larger than the inner diameter of the fluid path, and an abutting wall is formed at a connection position between the first rear opening and the fluid path; and
the front end of the collar body abuts the abutting wall of the tube body.

5. The fluid connector as claimed in claim 1, wherein a diameter of the first front opening of the tube body is smaller than the inner diameter of the fluid path, and the inner diameter of the collar body is smaller than the diameter of the first front opening; and
the valve comprises
a head matching with the first front opening;
a valve body matching with the fluid path; and
a spring mounted around the tail.

6. The fluid connector as claimed in claim 2, wherein a diameter of the first front opening of the tube body is smaller than the inner diameter of the fluid path, and the inner diameter of the collar body is smaller than the diameter of the first front opening; and
the valve comprises
a head matching with the first front opening;
a valve body matching with the fluid path; and
a spring mounted around the tail.

7. The fluid connector as claimed in claim 5 further comprising a first seal mounted around the head of the valve and sealing the first front opening.

8. The fluid connector as claimed in claim 6 further comprising a first seal mounted around the head of the valve and sealing the first front opening.

9. The fluid connector as claimed in claim 7, wherein an outer engaging portion, a protruding flange, an outer thread are formed on an outer side of the tube body from front to rear and a second seal is mounted around the outer side of the tube body and located between the protruding flange and the outer thread.

10. The fluid connector as claimed in claim 8, wherein an outer engaging portion, a protruding flange, an outer thread are formed on an outer side of the tube body from front to rear and a second seal is mounted around the outer side of the tube body and located between the protruding flange and the outer thread.

11. A fluid connector comprising
a tube body having a first front opening, a fluid path, and a first rear opening communicating with each other and arranged from a front end to a rear end of the tube body, wherein a diameter of the first rear opening is larger than an inner diameter of the fluid path, and an abutting wall is formed at a connection position between the first rear opening and the fluid path;
a supporting collar mounted in the first rear opening of the tube body and comprising
a collar body having an inner diameter smaller than the inner diameter of the fluid path of the tube body and a front end abutting the abutting wall of the tube body; and
a first thread formed on an outer surface of the collar body and screwed onto an inner surface of the first rear opening of the tube body;
a valve mounted slidably in the fluid path of the tube body and selectively sealing the first front opening of the tube body; and
a spring held in the fluid path of the tube body and having two ends abutting respectively with the valve and a front end of the supporting collar.

12. The fluid connector as claimed in claim 11, wherein
an inner thread is formed on the inner surface of the first rear opening of the tube body; and
the first thread on the supporting collar is an outer thread screwed onto the inner thread of the tube body.

13. The fluid connector as claimed in claim 11, wherein a diameter of the first front opening of the tube body is smaller than the inner diameter of the fluid path, and the inner diameter of the collar body is smaller than the diameter of the first front opening; and
the valve comprises
a head matching the first front opening;
a valve body matching the fluid path; and
a spring mounted around the tail.

14. The fluid connector as claimed in claim 12, wherein a diameter of the first front opening of the tube body is smaller than the inner diameter of the fluid path, and the inner diameter of the collar body is smaller than the diameter of the first front opening; and
the valve comprises
a head matching the first front opening;
a valve body matching the fluid path; and
a spring mounted around the tail.

15. The fluid connector as claimed in claim 13 further comprising a first seal mounted around the head of the valve and sealing the first front opening.

16. The fluid connector as claimed in claim 14 further comprising a first seal mounted around the head of the valve and sealing the first front opening.

17. The fluid connector as claimed in claim 13, wherein the supporting collar is made of metal.

18. The fluid connector as claimed in claim 14, wherein the supporting collar is made of metal.

19. The fluid connector as claimed in claim 17, wherein an outer engaging portion, a protruding flange, an outer thread are formed on an outer side of the tube body from front to rear and a second seal is mounted around the outer side of the tube body and located between the protruding flange and the outer thread.

20. The fluid connector as claimed in claim 18, wherein an outer engaging portion, a protruding flange, an outer thread are formed on an outer side of the tube body from front to rear and a second seal is mounted around the outer side of the tube body and located between the protruding flange and the outer thread.
